(19) United States
(12) Patent Application Publication
(10) Pub. No.: US 2010/0079773 A1
(43) Pub. Date: Apr. 1, 2010

(54) METHOD FOR PRINTING A COMPOSED DOCUMENT FROM MULTIPLE PRINT JOBS

(75) Inventor: Hao HU, Belmont, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/239,818

(22) Filed: Sep. 29, 2008

(51) Int. Cl. G06K 15/02

(52) U.S. Cl. 358/1.5

(57) ABSTRACT

A printing method that allows a user to conveniently compose and print a document that includes multiple portions from multiple original documents. The method may be implemented as a separate printer driver program or as a part of another printer driver program. The printer driver program displays images of the original documents, and allows the user to select blocks from the original documents. The program then automatically arranges the selected blocks of image into one or more pages, and prints the resulting pages. Thus, only the selected blocks of image are printed. The program additionally allows the user to rearrange the blocks on the pages before printing. A graphical user interface (GUI) is implemented to interact with the user in this process.

### BACKGROUND OF THE INVENTION

1. Field of the Invention

This invention relates to a printing method and related apparatus, and in particular, it relates to a method and apparatus for generating and printing a composed document that include portions of multiple original documents.

2. Description of Related Art

When a user prints pages of a document, it often happens that only portions of the printed pages contain information useful to the user. For example, it may be that on a multiple page document, only some portions of some pages contain useful information. The print function of most conventional programs has the ability of printing selected pages of a document, but does not offer the ability to print portions of pages. Thus, if only small portions of each page contain useful information, paper and toner are wasted on printing areas with useless information. Additionally, the useless information makes it harder for the user to locate the useful information on the page. Users often have to manually highlight the useful portions of using a marker. Also, if the user desires to organize the useful information, such as putting blocks of useful information on the same sheet of paper, he has to manually cut and paste the information into a new document and print the new document. For example, to plan a trip, the user may have flight information, hotel information, car rental information, local maps, etc., in separate documents. Such information is typically distributed in multiple original documents such as web pages, emails, etc., and each document typically contains other information that the user does not need. The user will have to either print all of the documents, or cut and paste the multiple pieces of useful information into a new document if he desires to have all useful information printed onto one piece of paper. This is wasteful and inconvenient.

### SUMMARY

Accordingly, the present invention is directed to a method and related apparatus that substantially obviate one or more of the problems due to limitations and disadvantages of the related art.

An object of the present invention is to provide a printing method and related apparatus that allow a user to conveniently organize and print information.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a printing method which includes: (a) a user opening a first original document using an application program and activating a print function of the application program; (b) the user selecting a composition printer as a destination printing device; (c) a printer driver of the composition printer displaying one or more images representing the first original document; (d) the user selecting one or more blocks of the images to be included in a composed document; (e) the printer driver arranging the blocks of images into one or more pages to generate the composed document; and (f) the printer driver submitting the composed document to a printer for printing. In the step (e) the arrangement of the blocks is preferably carried out automatically. In this instance, the arrangement of the blocks can be adjusted by user per user's request.

In another aspect, the present invention provides a printing method which includes: (a) receiving a first user input for generating a composed document based on a first original document; (b) rendering one or more images representing the first original document; (c) displaying the images; (d) receiving a second user input defining one or more blocks of the images to be included in the composed document; (e) arranging the blocks of images into one or more pages to generate a composed document; and (f) submitting the composed document to a printer for printing.

In another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1A-1C schematically illustrates a composition printing method according to an embodiment of the present invention.

FIG. 2 is flow diagram illustrating a printing process according to embodiments of the present invention.

### DETAILED DESCRIPTION OF PREFERRED EMBODIMENTS

Embodiments of the present invention provide a printing method that allows a user to conveniently compose and print a document that includes multiple portions from multiple original documents. The method may be implemented as a separate printer driver program or as a part of another printer driver program. A graphical user interface (GUI) is implemented to interact with the user in the printing process. The program may be executed by a general purpose computer having a structure familiar to those skilled in the relevant art.

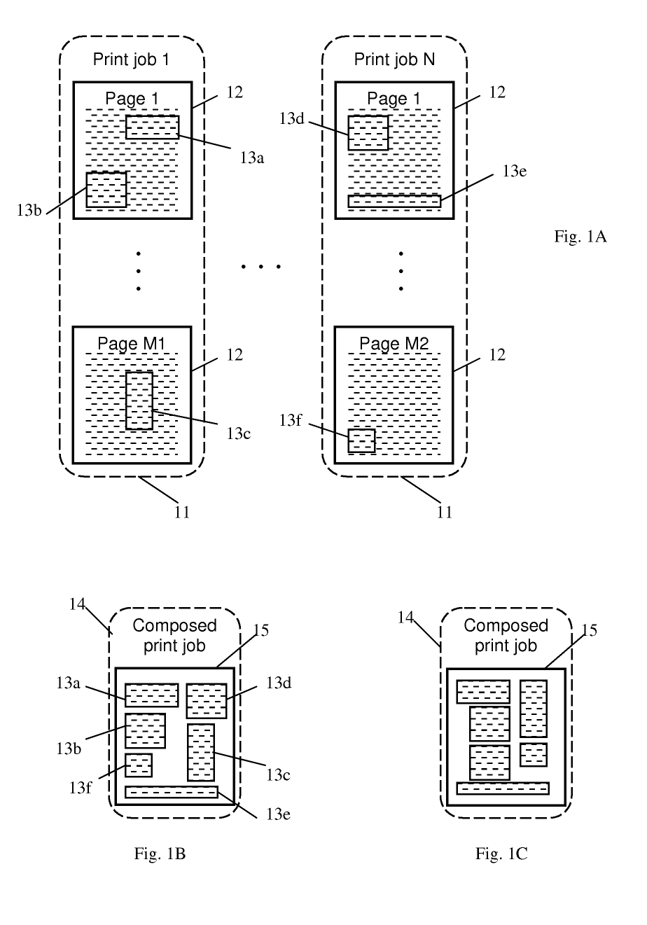

FIGS. 1A-1C schematically illustrate a method for printing a composed document according to embodiments of the present invention. FIG. 1A schematically illustrates one or more print jobs 11 (print jobs 1 to N), each print job containing one or more pages 12. Each print job 11 may be a document created by an application such as a word processing application, an image viewing or manipulation application, an email application, a web browser, etc. The source documents for the print jobs may have any suitable format, such as Word, PDF, JPEG, Tiff, text, html, etc. Some of the pages 12 of the print jobs 11 contain useful content, i.e. content the user desires to print. FIG. 1A schematically shows blocks of useful contents 13a-13f scattered across the multiple pages 12 of the multiple print jobs 11. Using tools provided by the printer driver program described in this disclosure, the user selects from the print jobs the blocks of content to be printed 13a-13f. As schematically shown in FIG. 1B, the program generates and prints a composed print job 14 that includes the user selected blocks 13a-13f rearranged to fit on one or more pages 15. Non-selected portions of the original print jobs 11 are not included. The program automatically arranges the selected blocks to form a composed document for printing. The program may additionally allow the user to rearrange the selected blocks on the composed pages. For example, the program may automatically arrange the blocks into an arrangement shown in FIG. 1B, and the user may rearrange them into that shown in FIG. 1C.

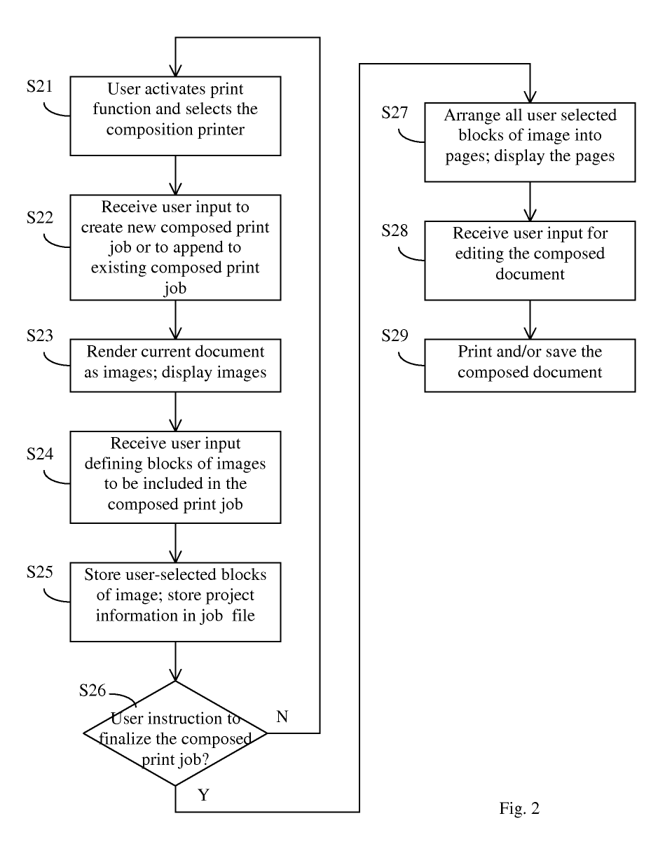

FIG. 2 illustrates a printing process according to embodiments of the present invention. As mentioned earlier, the method may be implemented as a printer driver program installed on a user's computer. When the user activates the print function from within an application (e.g., a word processing application, a PFD viewer, a web browser, etc.) to print a job, a special printing device, referred to here as a “composition printer”, will appear as one of the installed printers. The user selects the composition printer as the destination device (step S21). Then, the program prompts the user to either create a new composed print job and enter a job name for it, or enter the name of an existing composed print job and append the current print job to the existing composed print job. A dialog box may be used for this purpose. The user then “prints” the current document to the composition printer (i.e. by clicking a “print” or “OK” button) (step S22). In step S22, the program preferably allows the user to specify a page range of the document to be printed.

The pages of the document are rendered as images with printable quality (i.e. 300×300 or 600×600 DPI) and displayed on the screen (e.g. in a preview window) (step S23). In one implementation under the Windows operating system, the application program calls the Windows Graphics Device Interface (GDI) functions and the printer driver renders the images based on the GDI functions. Using the displayed image, the user selects portions (blocks) of the pages that he wishes to be included in the composed print job (step S24). GUI tools are provided for the user to navigate through the pages and select blocks of the images. GUI tools may also be provided to allow the user to input annotations about the composed print job or about selected blocks, add highlights, etc. The program stores the user-selected blocks of images (step S25), preferably as lossless compressed images such as PNG or TIFF format files.

Also, for each new composed print job, a job file is created (this may be done after the user creates a new composed print job). Step S25 also includes storing information about the composed print job in the job file. Such information may include filenames for the image files generated from the selected blocks, user added annotations or highlights, etc. The job file can be implemented in any suitable format, such as an XML file.

After processing a print job, the user may instruct the program to finalize the composed print job, or the user may repeat steps S21 to S25 for additional documents he wishes to include in the composed print job. For example, the program may display a dialog box to prompt the user whether he wishes to finalize the composed print job or to add more documents. Alternatively, the user may simply leave the printer driver program, open another original document in an application and activates the print function of that application, and repeats step S21 to S25. The application programs used to open the original documents may be different application programs.

If the user instructs the program to finalize the composed print job (“Y” in step S26), the program automatically arranges all of the blocks of image selected for the composed print job into one or more pages to generate a composed document, renders images of the composed document, and displays the images on the screen (e.g. in a preview window) (step S27). The blocks of image from all documents are arranged together into the one or more pages; in other words, blocks of image from different documents may be arranged on the same page. Preferably, the blocks are arranged by taking into consideration their shapes and sizes so that the space on the pages is efficiently utilized. The arrangement may additionally take into consideration the sequence in which the blocks have been added to the composed print job. Using the preview images, the program allows the user to optionally edit the composed print job (step S28), such as rearranging (moving) the blocks of image on the pages, cropping the blocks, resizing the blocks, adding annotations, adding highlights (e.g. using digital markers to highlight particular areas), etc. Appropriate GUI tools are provided to accomplish these editing operations. After steps S27 and S28, the program updates the job file to store coordinates of the arranged blocks of images and other pertinent information.

After the user is satisfied with the layout of the composed pages, the composed document is printed on a physical printer or saved as a file (step S29). The printed document also includes the annotations and highlights if they have been inputted by the user. To print the document on a physical printer, the program implements a print function similar to the print function of conventional applications. A printer dialog box may be displayed for the user to select a physical printer to print to. The program then prints the composed document to the selected printer. In addition to the blocks of image, the annotations and highlights are also rendered and printed. To save a composed document, the program may save the job file along with the image files for the blocks of images. Alternatively, the program may generate an image file representing the composed document and save it.

As mentioned earlier, a GUI is implemented to interact with the user in the above process. The GUI may take any suitable form, and use any suitable means to allow the user to enter instructions and input values and to manipulate images. Such GUI tools are well known to those skilled in the programming art and will not be described in detail here.

In addition to above described functions, the program can manage multiple composed print jobs simultaneously. A composed print job management window may be displayed to list all existing composed print jobs, and allow the user to add more contents to a composed print job, or edit a composed print job, delete a composed print job, etc. Deleting a composed print job will delete all related files including the job file and image files for the selected image blocks.

The above descriptions use a separate printer driver program as an example. If the composite printing function is implemented as a part of a printer driver for an actual physical printer, step S21 and S29 will be modified and other steps will remain the same. In step S21, instead of selecting the composition printer as the destination device, the printer driver will prompt the user to select either regular printing (i.e. printing the current document to the physical printer) or composition printing. In step S29, instead of prompting the user to select an actual printer, the printer driver program will print the composed document to its own printer.

As another alternative, the printing method described above may also be implemented as a utility program. The utility program invokes appropriate application programs such as work processing program, web browser programs, etc. to open the original documents to be printed and carries out composition printing. Implementation of such a utility program can be accomplished by those skilled in the art based on the description above.

The composition printing method described herein has many advantages. It avoids printing unnecessary content, thereby conserving paper and toner. It makes it easier to organize information on a printed page, and avoids distraction by unwanted contents.

It will be apparent to those skilled in the art that various modification and variations can be made in the printing method and related apparatus of the present invention without departing from the spirit or scope of the invention. Thus, it is intended that the present invention cover modifications and variations that come within the scope of the appended claims and their equivalents.

What is claimed is:

1. A printing method comprising:
(a) receiving a first user input for generating a composed document based on a first original document;
(b) rendering one or more images representing the first original document;
(c) displaying the images;
(d) receiving a second user input defining one or more blocks of the images to be included in the composed document;
(e) arranging the blocks of images into one or more pages to generate a composed document; and
(f) submitting the composed document to a printer for printing.

2. The method of claim 1, further comprising:
(g) receiving a third user input for including a second original document in the composed document; and
(h) repeating steps (b) to (d) for the second original document,
wherein step (e) includes arranging the blocks of the images of the first original document and blocks of the images of the second original document together onto the one or more pages.

3. The method of claim 1, further comprising:
(i) displaying the composed document generated in step (e);
(j) receiving a fourth user input defining a rearranging, cropping, or resizing of the blocks of images of the composed document; and
(k) rearranging, cropping or resizing the blocks of images based on the fourth user input to re-generate the composed document.

4. The method of claim 1, further comprising:
(l) receiving a fifth user input defining one or more annotations or highlights, wherein step (e) includes including the annotations or highlights in the composed document.

5. The method of claim 1, further comprising:
(m) storing the blocks of images as image files.

6. The method of claim 5, further comprising:
(n) generating a job file defining the composed document, the job file including filenames of the image files stored in step (m), coordinates of the blocks of images in the composed document, and information regarding user added annotations or highlights.

7. A printing method comprising:
(a) a user opening a first original document using an application program and activating a print function of the application program;
(b) the user selecting a composition printer as a destination printing device;
(c) a printer driver of the composition printer displaying one or more images representing the first original document;
(d) the user selecting one or more blocks of the images to be included in a composed document;
(e) the printer driver arranging the blocks of images into one or more pages to generate the composed document; and
(f) the printer driver submitting the composed document to a printer for printing.

8. The method of claim 7, further comprising:
(g) repeating steps (a) to (d) for a second original document;
wherein step (e) includes arranging the blocks of the images of the first original document and blocks of the images of the second original document together onto the one or more pages.

9. The method of claim 7, further comprising:
(h) the printer driver displaying the composed document generated in step (e);
(i) the user editing the composed document, including rearranging, cropping, or resizing the blocks of images of the composed document; and
(j) the printer driver re-generate the composed document based on the user editing in step (i).

10. The method of claim 7, further comprising:
(k) the user inputting one or more annotations or highlights,
wherein step (e) includes including the annotations or highlights in the composed document.

11. The method of claim 7, further comprising:
(l) the printer driver storing the blocks of images as image files.

12. The method of claim 11, further comprising:
(n) the printer driver generating a job file defining the composed document, the job file including filenames of the images files stored in step (m), coordinates of the blocks of images in the composed document, and information regarding user added annotations or highlights.

13. A computer program product comprising a computer usable medium having a computer readable program code embedded therein for controlling a data processing apparatus, the computer readable program code configured to cause the data processing apparatus to execute a printing process comprising:
(a) receiving a first user input for generating a composed document based on a first original document;
(b) rendering one or more images representing the first original document;
(c) displaying the images;
(d) receiving a second user input defining one or more blocks of the images to be included in the composed document;
(e) arranging the blocks of images into one or more pages to generate a composed document; and
(f) submitting the composed document to a printer for printing.

14. The computer program product of claim 14, wherein the process further comprises:
(g) receiving a third user input for including a second original document in the composed document; and
(h) repeating steps (b) to (d) for the second original document,
wherein step (e) includes arranging the blocks of the images of the first original document and blocks of the images of the second original document together onto the one or more pages.

15. The computer program product of claim 14, wherein the process further comprises:
(i) displaying the composed document generated in step (e);
(j) receiving a fourth user input defining a rearranging, cropping, or resizing of the blocks of images of the composed document; and
(k) rearranging, cropping or resizing the blocks of images based on the fourth user input to re-generate the composed document.

16. The computer program product of claim 14, wherein the process further comprises:
(l) receiving a fifth user input defining one or more annotations or highlights, wherein step (e) includes including the annotations or highlights in the composed document.

17. The computer program product of claim 14, wherein the process further comprises:
(m) storing the blocks of images as image files.

18. The computer program product of claim 17, wherein the process further comprises:
(n) generating a job file defining the composed document, the job file including filenames of the image files stored in step (m), coordinates of the blocks of images in the composed document, and information regarding user added annotations or highlights.
